(19) United States
(12) Patent Application Publication
(10) Pub. No.: US 2003/0141386 A1
(43) Pub. Date: Jul. 31, 2003

(54) Injector body with tangential pressure connection

(75) Inventors: Werner Wagner, Gerlingen (DE); Stefan Haug, Waldenbuch (DE)

Correspondence Address: RONALD E. GREIGG, GREIGG & GREIGG P.L.L.C., 1423 POWHATAN STREET, UNIT ONE, ALEXANDRIA, VA, 22314, US

(73) Assignee: Robert Bosch GmbH

(21) Appl. No.: 10/236,925

(22) Filed: Sep. 9, 2002

(30) Foreign Application Priority Data
Sep. 7, 2001 (DE) 1 01 43 947.4

(51) Int. Cl. F02M 59/00

(52) U.S. Cl. 239/533.2

(57) ABSTRACT

A fuel injector for injecting fuel into the combustion chamber of an internal combustion engine includes an injector body in which an annular chamber into which an inlet bore discharges at an orifice point is embodied. A pressure tube neck with a sealing face is embodied on the injector body. The pressure tube neck is offset from the line of symmetry of the annular chamber; the inlet bore, embodied in the pressure tube neck, ends at a tangent, at an obtuse entrance angle, in the annular chamber at the orifice point.

### BACKGROUND OF THE INVENTION

1. Field of the Invention

In direct-injection internal combustion engines, fuel injection systems with a high-pressure collection chamber (common rail) are increasingly used at present. By means of a high-pressure pump subjected permanently to the high-pressure collection chamber, a virtually constant, high pressure level is maintained in the high-pressure collection chamber. The fuel stored at a high pressure level in the high-pressure collection chamber is carried on to the fuel injectors, which each are assigned to the individual combustion chambers of the engine. More stringent demands in terms of high-pressure strength must therefore be made of the fuel injectors, the supply lines from the high-pressure collection chamber and their connections, and the inflow system inside the injector body.

2. Description of the Prior Art

DE 196 50 865 A1 relates to a magnet valve for controlling a fuel injection valve. A magnet valve is proposed whose magnet armature is embodied in multiple parts and has both an armature disk and an armature bolt, the latter guided in a slide element. To avoid continued vibration of the armature disk after a closure of the magnet valve, a damping device is provided on the magnet armature. With such a device, the requisite short switching times of the magnet valve can be maintained and can be reproduced during operation. The magnet valve is intended for use in injection systems with a high-pressure collection chamber (common rail).

In this version, a connection for a supply line from the high-pressure collection chamber on the valve housing is received, oriented obliquely, which makes it possible to improve the high-pressure strength of a fuel injector. The improvement in high-pressure strength attainable with this provision is unsatisfactory, however, since in view of a further increase in the pressure level in the high-pressure collection chamber (common rail), the gain in high-pressure strength obtained by this provision will be diminished again in the course of further progress in development.

### OBJECT AND SUMMARY OF THE INVENTION

With the embodiment according to the invention, the weak point in the injector body that determines the strength of the injector body can be overcome, unlike conventional versions. The point of intersection of the inlet bore and the annular conduit is exposed to the most extreme mechanical stresses, because of the internal pressure prevailing in the injector body and because of static installation/mounting forces; these stresses can be reduced considerably by means of an oblique positioning of the inlet bore or by means of its eccentric entrance into the annular conduit inside the injector body. Not only is the injector body stressed by the internal pressure prevailing in the annular conduit, but the inlet bore in the pipe connection or pressure tube neck is also exposed to mechanical stresses from an introduction of force at the point where the high-pressure line from the high-pressure collection chamber is screwed in. The introduction of the screwing forces in the region of the pipe neck causes the neck to expand radially in the thread region; superimposed on this mechanical stress is the internal pressure stress that is generated by the inflowing fuel, which is at very high pressure and flows in from the high-pressure collection chamber (common rail) into the annular chamber of the injector body through the inlet bore. The embodiment according to the invention provides for pivoting the pressure tube neck and accordingly the inlet bore received in it; with an offset or pivoted arrangement of the pressure tube neck relative to the axis of symmetry of the annular chamber, the strength is maintained because of a perpendicular or in other words vertical course of the inlet bore from the sealing face of the pressure tube neck with the downstream female thread, while the mechanical stresses at the weak point in terms of strength, that is, at the transition from the orifice of the inlet bore into the annular conduit, can be reduced considerably.

The pivoting of the pressure connection geometry, or its offset relative to the axis of symmetry of the annular conduit to an eccentric inlet position relative to the axis of symmetry of the injector body, can be converted by means of a simple modification of the forged blank for the injector body, without requiring further provisions that entail effort and expense in terms of production. If in one of the variant embodiments of the present invention, especially obtuse entrance angles of the inlet bore into the annular chamber in the injector body can be attained, then the gain in strength is considerable. The more obtusely the entrance angle of the inlet bore can be embodied, the greater is the gain in strength obtained at the injector body.

### BRIEF DESCRIPTION OF THE DRAWING

The invention will be better understood and further objects and advantages thereof will become more apparent from the ensuing detailed description of preferred embodiments taken in conjunction with the drawings, in which:

FIGS. 1 and 2 show a version of an injector, known from the prior art, in longitudinal and cross section, respectively;

FIG. 3 shows an inlet bore, received in pivoted form in the pressure tube neck of an injector body;

FIG. 4 shows a pressure tube neck, disposed on the injector body offset from the axis of symmetry thereof; and

FIG. 5 shows a pressure tube neck disposed in a pivoted position on the injector body.

### DESCRIPTION OF THE PREFERRED EMBODIMENTS

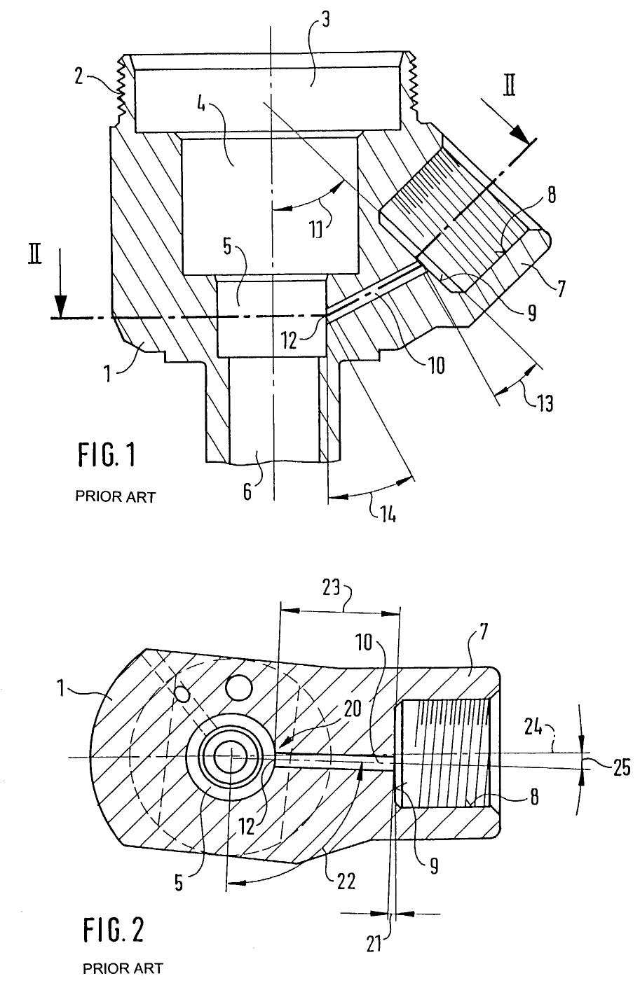

FIG. 1 shows a mass-produced injector body, known from the prior art, of a fuel injector in longitudinal section. The sectional view in FIG. 1 shows an injector body 1, in whose upper region a male thread 2 is received. A magnetic sleeve, not shown here, which surrounds an electromagnet with which an actuating element, not shown here, for pressure relief of a control chamber, also not shown here, can be actuated is secured to the male thread 2. In the injector body 1, an installation space 3 for the electromagnet is provided; this magnet is secured to the injector body 1 by screwing a magnetic sleeve onto the male thread 2. Below the installation space 3 for receiving the magnet valve, an installation space 4 is provided, which receives an armature assembly, configured in one part or multiple parts, not shown. Below the installation space 4, an annular chamber 5 is shown, which is subjected to fuel that is at extremely high pressure. Below the annular chamber 5 in the injector body 1, a guide portion 6 follows, for a tappet/nozzle needle assembly, also not shown in the view of FIG. 1. Laterally on the injector body 1, a pressure tube neck 7 is received, which may be provided with a female thread 8. A connection piece of a high-pressure line can be screwed into the female thread, and by way of this piece the injector body of the fuel injector, for injecting fuel into the combustion chamber of an internal combustion engine, communicates with a supply from the high-pressure collection chamber (common rail).

The fuel stored in the common rail is kept at a constantly high level via a high-pressure pump, and the individual fuel injectors can be acted upon, in the injection sequence of the engine, by fuel at high pressure from common rail. Because of the high pressure prevailing in the common rail, pressure pulsations and pressure fluctuations in the fuel are compensated for, so that a constant injection pressure always prevails at the individual fuel injectors associated with the combustion chambers of the engine.

From the sealing face 9 in the pressure tube neck 7, an inlet bore 10 extends in the direction of the annular chamber 5 in the injector body 1 and discharges in the annular chamber 5 at an orifice point 12. From the longitudinal section in FIG. 1, it can be seen that the inlet bore branches off from the sealing face 9 at an angle 13, in the present case an acute angle 13, and discharges into the annular chamber 5 at a likewise acute angle 14, relative to the axis of symmetry of the annular chamber 5. Reference numeral 11 indicates the angle of inclination of the sealing face 9, embodied in the pressure tube neck 7, relative to the axis of symmetry of the annular chamber 5.

FIG. 2 shows a cross section through the injector body of FIG. 1, taken along the line II-II.

From the cross-sectional view of the injector body 1 in FIG. 2, it can be seen that the inlet bore 10 extends at a length 23 from the sealing face 9 of the pressure tube neck 7 to the wall of the annular chamber 5. Along with the oblique position visible in FIG. 1, by the angle 13 relative to the longitudinal axis, the inlet bore 10 runs at an angle of inclination 21 from the sealing face 9 toward the annular chamber 5. In the annular chamber 5, the inlet bore 10 discharges at an orifice point 12, essentially at the running angle 22, which in the view of FIG. 2 is shown as a right angle. Accordingly, the inlet bore 10 discharges approximately centrally in the annular chamber 5, and as a result in the region of the orifice point 12, there is a region of reduced high-pressure strength, because of the selected orifice length. The sharp corners, especially, of the inlet bore 10 in the region of the orifice point 12 are subjected to extreme mechanical stresses by the incident pressure stresses. The inlet bore 10 as shown in FIG. 2 extends at an oblique position 25 relative to the line of symmetry 24 of the pressure tube neck 7.

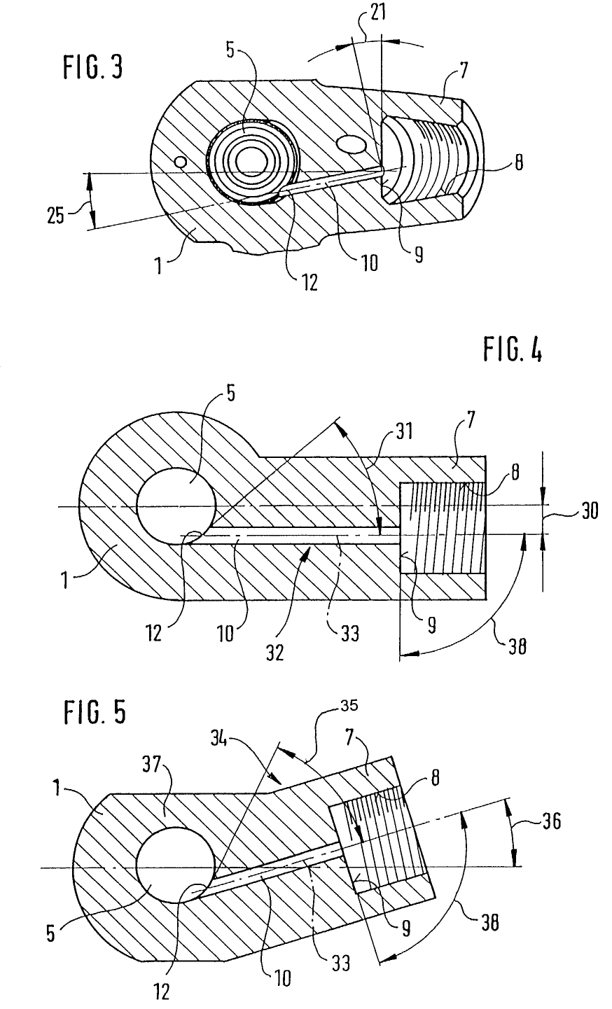

FIG. 3 shows an inlet bore 10 that relative to the annular chamber to be acted upon extends at a tangent in the pressure tube neck of an injector body.

It can be seen from the view in FIG. 3 that the inlet bore 10 now no longer discharges centrally (as in FIG. 2) into the annular chamber 5, but instead that the orifice point 12 of the inlet bore 10 discharges at a tangent into the annular chamber 5. The oblique position of the inlet bore 10 in the injector body 1 is defined by the angle 25. Also in the view in FIG. 3, an acute angle 21 is established in the region of the sealing face 9 between the orientation of the sealing face 9 in the pressure tube neck 7 and the conduit cross section of the inlet bore 10, and this can represent a potential weak point or leakage point.

FIG. 4 shows a pressure tube neck disposed on the injector body in a way that is offset from the axis of symmetry of the injector body.

From the view in FIG. 4, it can be seen that the pressure tube neck 7 is offset relative to the annular chamber 5 embodied in the injector body 1. The offset arrangement of the pressure tube neck 7 can be modified by simple provisions in production of the forged blank for the injector body 1, so that an offset 30 is established between the line of symmetry of the pressure tube neck 7 and the axis of symmetry, extending perpendicular to the plane of the drawing, of the annular chamber 5 in the injector body 1. In the view of FIG. 4, the line of symmetry 33 of the inlet bore 10 and the line of symmetry of the pressure tube neck 7 coincide. Unlike the inlet bores 10 shown in FIGS. 1-3, the inlet point of the inlet bore 10 in the sealing face 9 branches off from the sealing face at a right angle 38, or in other words perpendicular to the plane sealing face 9. On the one hand, this makes sealing easier at the transition point from the high-pressure line, not shown here, to the pressure tube neck 7, and on the other hand, it reduces the mechanical stresses down to an unavoidable minimum. The inlet bore 10, in the view of the injector body 1 shown in FIG. 4, extends parallel to the axis of symmetry of the pressure tube neck and discharges in the wall of the annular chamber 5, at the orifice point 12, at a first obtuse entrance angle 31. Because the inlet bore 10 discharges at a tangent into the annular chamber 5 of the injector body 1, the mechanical stress at the orifice point 12 of the inlet bore into the annular chamber 5 is reduced considerably. Moreover, the acute angle 21 shown in FIG. 3, by which the inlet bore 10 shown there branches off from the sealing face 9 is omitted. On the one hand, this considerably simplifies the manufacture of the inlet bore 10 in the injector body 1, and on the other, the mechanical stresses prevailing in the entrance region of the inlet bore 10 because of the fuel shooting into the inlet bore 10 at high pressure can be reduced considerably as a result of the arrangement shown in FIG. 4.

A further variant of the embodiment proposed according to the invention can be seen in FIG. 5, which shows a pressure tube neck disposed in a pivoted position on the injector body.

The pivoted disposition of the pressure tube neck 7 relative to the injector body 1 is indicated by reference numeral 34. In this arrangement as well, the inlet bore 10, relative to the sealing face 9 of the pressure tube neck 7, extends perpendicularly to the sealing face in the direction of the annular chamber 5 of the injector body 1. The entrance angle at the orifice point 12 is marked by reference numeral 35; the variant of FIG. 5 involves a second obtuse entrance angle 35. In comparison to the variant of FIG. 4, the length of the inlet bore 10 between the sealing face 9 and the orifice point 12 is substantially shorter. Analogously to the first variant of FIG. 4, the axis of symmetry 33 of the inlet bore 10 and the axis of symmetry of the pressure tube neck 7 coincide. The oblique position relative to the pressure tube neck 7 or inlet bore 10 is characterized, in the second variant embodiment of FIG. 5, by the oblique positioning angle 36, which designates the angular offset between the line of symmetry 33 of the inlet bore 10 and pressure tube neck 7 and the horizontal, relative to the annular chamber 5 of the injector body 1. The pressure tube neck 7, which in the second variant embodiment of FIG. 5 is pivoted relative to the injector body 1, can also receive a female thread 8, to which a high-pressure line, leading from the high-pressure collection chamber to the injector body 1, can be screwed. Because an acute angle 21 is avoided between the entry point into the inlet bore 10 and the sealing face 9, an adequate sealing effect can be attained because of the plane position of the faces, while the attainable entrance angle 35 of the inlet bore 10 at a tangent to the wall of the annular chamber 5 is dependent on the choice of the oblique positioning angle 36. The more obtuse the entrance angle 31 or 35 into the annular chamber 5 inside the injector body 1 can be selected to be, the more favorable is the resultant mechanical stress on the injector body 1, whose wall is marked by reference numeral 37.

The embodiment of a substantially obtuse entrance angle 31 or 35, of the variant embodiments of FIGS. 4 and 5, respectively, makes a substantially more favorable distribution of stress possible in the wall 37 of the injector body 1 that defines the annular chamber 5. This reserve strength is a safety aspect, on the one hand, and it also has a favorable effect on the service life of a fuel injector designed according to the invention; moreover, because of the selected configuration of the pressure tube neck 7 relative to the entrance angle into the annular chamber 5, a strength potential is available, which allows a further use of an injector body 1 configured according to the invention for an increasing pressure level in the common rail of a fuel injection system for an internal combustion engine.

The foregoing relates to preferred exemplary embodiments of the invention, it being understood that other variants and embodiments thereof are possible within the spirit and scope of the invention, the latter being defined by the appended claims.

We claim:

1. A fuel injector for injecting fuel into the combustion chamber of an internal combustion engine comprising
an injector body (1) in which an annular chamber (5) is embodied, and into which an inlet bore (10) discharges at an orifice point (12), and
a pressure tube neck (7) with a sealing face (9) embodied on the injector body (1),
the pressure tube neck (7) being disposed offset from the line of symmetry of the annular chamber (5), and
the inlet bore (10) embodied in the pressure tube neck (7) ending at a tangent at an obtuse entrance angle (31, 35) in the annular chamber (5) at the orifice point (12).

2. The fuel injector of claim 1 wherein the inlet bore (10) in the pressure tube neck (7) extends at a right angle from the sealing face (9) to the annular chamber (5).

3. The fuel injector of claim 1 wherein the pressure tube neck (7) is disposed at a lateral offset (30) from the axis of symmetry of the annular chamber (5).

4. The fuel injector of claim 3 wherein the axis of symmetry (33) of the inlet bore (10) coincides with the axis of symmetry of the pressure tube neck (7), and wherein the inlet bore (10) discharges into the annular chamber (5) at a first obtuse entrance angle (31).

5. The fuel injector of claim 1 wherein the pressure tube neck (7) is received in the injector body (1), pivoted by an oblique positioning angle (36).

6. The fuel injector of claim 5 wherein the inlet bore (10), in the pressure tube neck (7) that is disposed pivoted, discharges at a tangent, at a second obtuse entrance angle (35), into the annular chamber (5) of the injector body (1).
